(19) United States
(12) Patent Application Publication
(10) Pub. No.: US 2019/0319712 A1
(43) Pub. Date: Oct. 17, 2019

(54) AMPLITUDE COHERENT DETECTION FOR PULSE AMPLITUDE MODULATION SIGNALS

(71) Applicant: ZTE Corporation, Shenzhen (CN)

(72) Inventors: Junwen Zhang, Randolph, NJ (US); Jianjun Yu, Basking Ridge, NJ (US); Jun Shan Wey, Sammamish, WA (US)

(21) Appl. No.: 15/953,446

(22) Filed: Apr. 14, 2018

(51) Int. Cl. H04B 10/516; H04B 10/25; H04B 10/58; H04B 10/61

(52) U.S. Cl. CPC H04B 10/5161; H04B 10/25; H04B 10/614; H04B 10/6161; H04B 10/58

(57) ABSTRACT

Methods, systems and devices for amplitude coherent detection for pulse amplitude modulation (PAM) signals are described. One method for high-speed and high-capacity optical communication includes modulating an input signal based on pulse amplitude modulation, performing a pre-distortion operation on an output of the modulating, filtering an output of the pre-distortion operation using a pulse shaping filter, and transmitting an output of the filtering using intensity modulation, where the intensity modulation includes an equally-spaced amplitude distribution. Another method includes receiving an optical signal, performing a coherent detection operation on the optical signal, where the coherent detection comprises an equally-spaced amplitude distribution, converting an output of the coherent detection operation from an optical domain to an electrical domain by digitizing the output, filtering an output of the digitizing using a pulse shaping filter, and demodulating an output of the filtering using a pulse amplitude modulation demodulator.

### TECHNICAL FIELD

This document relates to digital communications, and in one aspect, optical communication systems that use pulse amplitude modulation.

### BACKGROUND

There is an ever-growing demand for data communication in application areas such as wireless communication, fiber optic communication and so on. The demand on core and access networks are all growing higher because not only are user devices such as smartphones and computers using more and more bandwidth due to multimedia applications, but also the total number of devices for which data is carried over the whole network is increasing. For profitability and to meet increasing demand, equipment manufacturers and network operators are continually looking for ways to support high-speed and high-capacity communication links.

### SUMMARY

This document relates to methods, systems, and devices for phase insensitive amplitude coherent detection for pulse amplitude modulation (PAM) signals. In some examples, equally-spaced amplitude levels are implemented for intensity modulation at the transmitter.

In one exemplary aspect, a digital communication method is disclosed. The method, which may be implemented at an optical transmitter, includes modulating an input signal based on pulse amplitude modulation, performing a pre-distortion operation on an output of the modulating, filtering an output of the pre-distortion operation using a pulse shaping filter, and transmitting an output of the filtering using intensity modulation, where the intensity modulation includes an equally-spaced amplitude distribution.

In another exemplary aspect, a digital communication method is disclosed. The method, which may be implemented at an optical receiver, includes receiving an optical signal, performing a coherent detection operation on the optical signal, where the coherent detection comprises an equally-spaced amplitude distribution, converting an output of the coherent detection operation from an optical domain to an electrical domain by digitizing the output, filtering an output of the digitizing using a pulse shaping filter, and demodulating an output of the filtering using a pulse amplitude modulation demodulator.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows a flowchart for an example method of optical communication.

FIG. 2 is a block diagram of an example optical communication system.

FIGS. 3A-3F shows various outputs and features of subcomponents of an example optical communication system.

FIGS. 4A-4H show various experimental results, including performance curves, of an example optical communication system.

FIGS. 5A and 5B show examples of modulation laser characteristics.

FIG. 6 shows an example of a single-polarization optical receiver structure.

FIG. 7 shows an example of a dual-polarization optical receiver structure.

FIG. 8 shows the spectra and corresponding time-domain pulses for a raised cosine pulse for various values of the roll-off factor.

FIG. 9 shows the spectra and corresponding time-domain pulses for a square-root raised cosine pulse for various values of the roll-off factor.

FIGS. 10A, 10B and 10C show the effect of truncation on the shaping pulse.

FIG. 11 shows a flowchart for an example method of optical communication.

FIG. 12 shows a flowchart for another example method of optical communication.

FIG. 13 is a block diagram representation of a portion of an optical transmitter or receiver apparatus.

### DETAILED DESCRIPTION

The advance of high-speed passive optical networks (PONs) has been propelled by new business and technology drivers, such as cloud services, 5G (Fifth Generation) wireless transport, and high bandwidth 4K/8K video applications. To meet these increased capacity needs, a passive optical network for access is moving from the classic spectrally inefficient non-return to zero (NRZ), to more advanced modulation formats with digital signal processing (DSP). This is further evidenced by the progress in standards bodies developing next generation high speed PON standards. Example implementations include the standardization of 25/50G Ethernet PON (EPON) based on wavelength multiplexing of 25 Gbps single channel, with 29 dB power budget by using low-density parity-check code (LDPC).

Despite these advances, an implementation of a 100G (100 Gigabit) PON via wavelength multiplexing of four 25 Gb/s channels is still currently an active area of industry and academic research and development. An initial challenge is that the wavelength multiplexer and demultiplexer typically add an additional ˜2.5 dB loss, which makes meeting the power budget even more difficult. Also, channel bonding of four 25 Gb/s channels may require a significant amount of 0-band wavelength resources.

A possible solution to achieving higher speed in PONs is to increase the data rate per wavelength, and may result in a 100G TDM-PON (time-division multiplexed PON) on a single wavelength, which not only reduces the number of optical components and the associated cost, but also conserves the wavelength resources. However, limited sensitivity is an issue for 100 Gb/s/λ, TDM-PON (where λ is the wavelength) to support a high power budget using direct detection.

Some existing implementations rely on coherent detection as an effective method to increase the receiver sensitivity. One example includes Ultra-Dense Wavelength Division Multiplexing (UDWDM) coherent PON with 16-QAM modulation of 10 Gb/s per wavelength, and another example includes a 100G PON based on 32 Gbaud dual-polarization QPSK signals. However, both these examples require complicated I/Q modulators as well as an integrated coherent receiver based on four 90° optical hybrids (where an optical hybrid is a four-port optical device with two inputs and two outputs) designed for long-haul transmissions. Furthermore, carrier phase recovery with considerable complexity is also required, which significantly increases the total power consumption of coherent receiver. Yet another example includes coherent detection of intensity modulated NRZ/OOK (on-off keying) based on low cost coherent receiver with simplified DSP, but requires a 3×3 fiber coupler to achieve a 25 Gb/s data rate.

The present application describes techniques that can be implemented to meet the above-discussed bitrates with none or insignificant increase in receiver complexity. Some embodiments of the disclosed technology include a single wavelength 100 Gb/s PAM-4 TDM-PON transmission in the C-band using simplified and phase insensitive heterodyne coherent detection. In some embodiments, 50-GBaud PAM-4 intensity (amplitude) modulation is performed without using any I/Q modulators. Compared to homodyne detection, heterodyne detection reduces the number of optical hybrids, photodetectors (PDs) and analog-to-digital converters (ADCs) of coherent receiver by half. As only the intensity of the carrier is modulated, carrier phase recovery can be avoided, which further reduces the DSP complexity and power consumption. In some embodiments, optimized Nyquist pulse shaping is also performed on PAM-4 signal to reduce the required transceiver bandwidth. For example, a receiver sensitivity of −26 dB is achieved for 100-Gb/s PAM-4 at BER threshold of 1×10⁻², which corresponds to a greater than 32-dB power budget being enabled after 20/40 km fiber transmission.

Experimental results have confirmed the benefits of the disclosed technology.

Section headings are used in the present document to improve readability of the description and do not in any way limit the discussion or the embodiments to the respective sections only.

Example Experimental Embodiment of an Optical Communication System

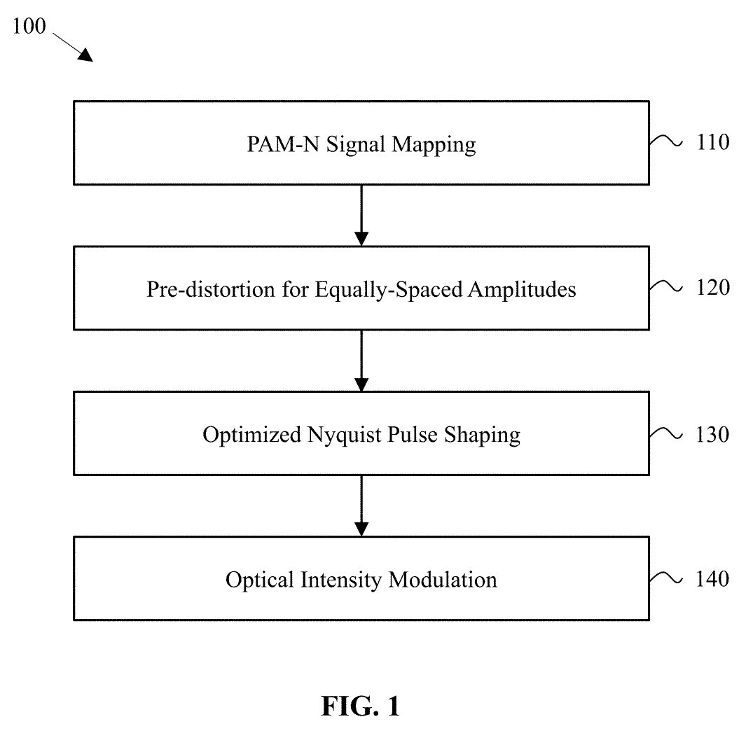

FIG. 1 shows a flowchart for an example method 100 of optical communication based on embodiments of the disclosed technology, and highlights some features that enable high-speed and high-capacity optical communication links. The method 100 includes, at step 110, PAM-N signal mapping that enables the carrier phase recovery to be avoided at the receiver. The intensity (or amplitude) modulation does not transmit any information in the phase of the signal, which reduces the DSP complexity and power consumption.

The method 100 includes, at step 120, a pre-distortion for equally-spaced amplitudes. In some embodiments, the pre-distortion is required to achieve an equally-spaced amplitude distribution after coherent detection by using intensity modulators. In other embodiments, the pre-distortion is based on the modulation response of the transmitter, including the linearization of any device nonlinearity, and the conversion of the equally-spaced amplitude signal to the corresponding intensity drive signal.

The method 100 includes, at step 130, optimized Nyquist pulse shaping, which is used to reduce the bandwidth of the signal, and consequently, to reduce the bandwidth required by the transceiver. In some embodiments, the optimization of the Nyquist pulse shape may be based on a strength of a clock signal and the bandwidth requirements of the system.

The method 100 includes, at step 140, optical intensity modulation, which may be implemented by direct modulation laser (DML), external modulation laser (EML) based on an electro-absorption modulated laser, or a Mach-Zehnder Modulator (MZM).

The features described in FIG. 1 advantageously enable an optical receiver for this system to implement simplified and phase insensitive heterodyne coherent detection and signal processing, as compared to traditional higher complexity solutions.

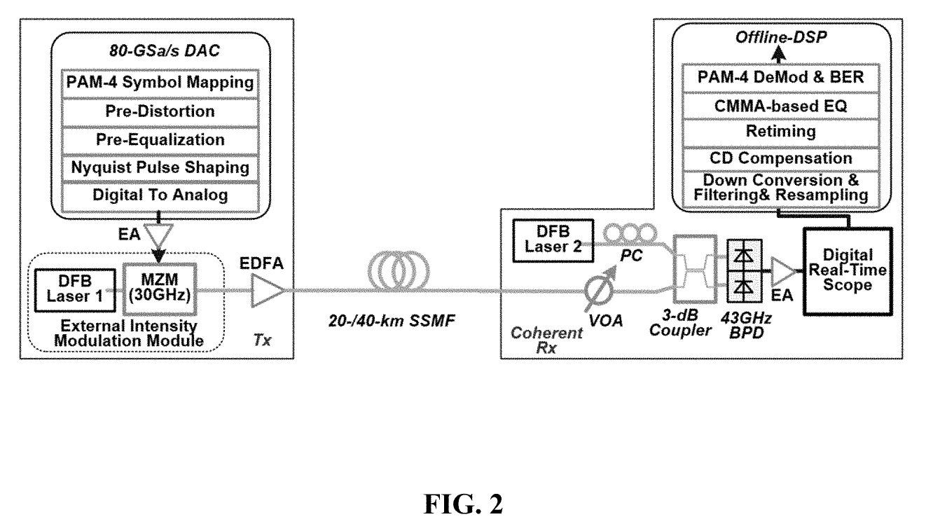

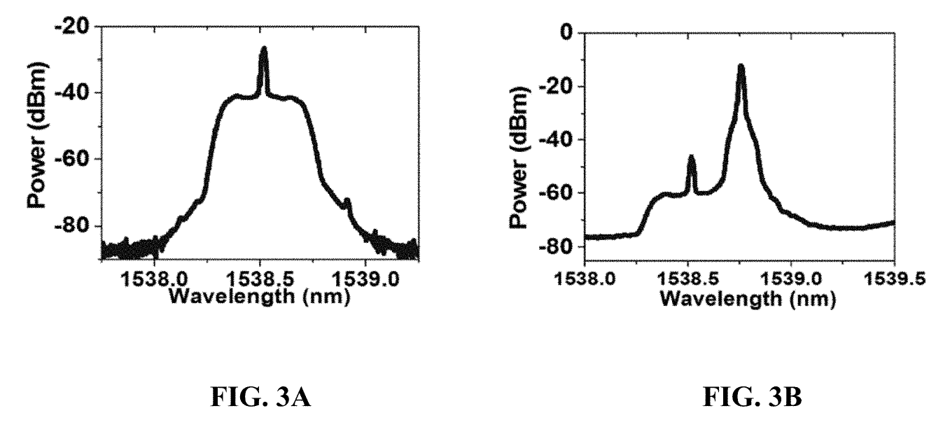

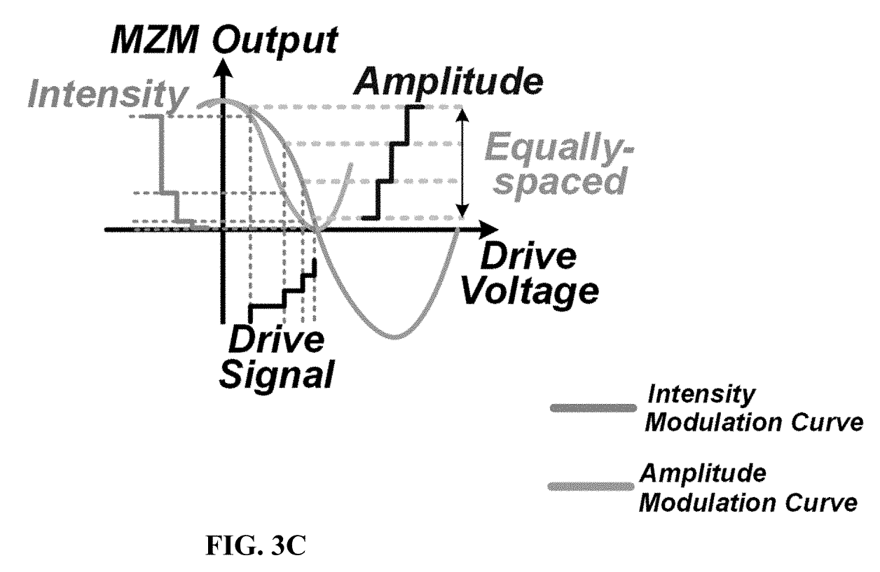

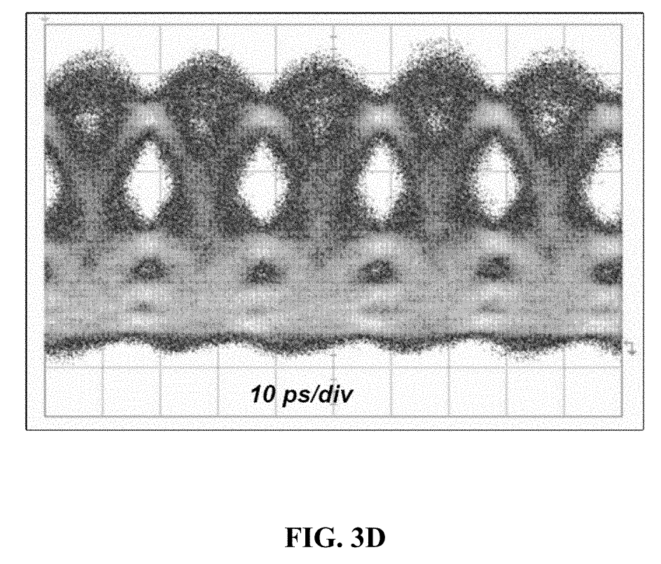

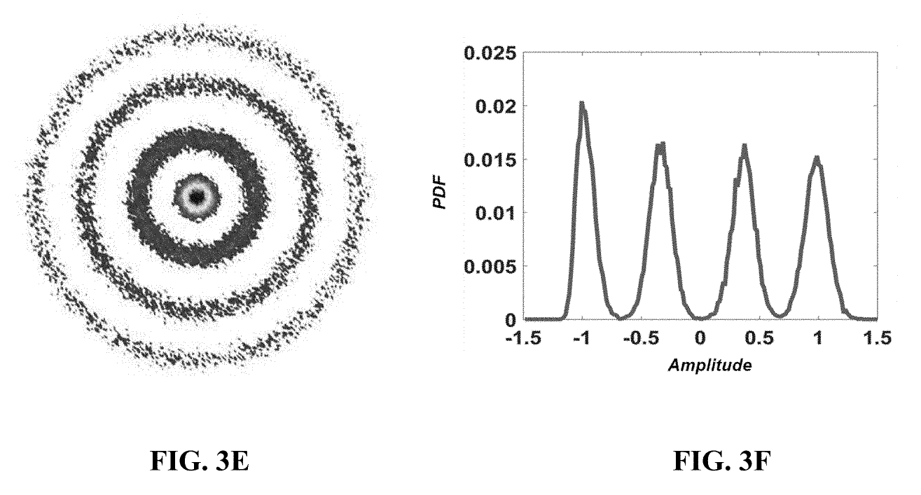

FIG. 2 shows a block diagram of an example implementation of an optical communication system for single-wavelength 100-Gb/s PAM-4 TDM-PON transmission in C-band based on simplified and phase insensitive heterodyne coherent detection. FIGS. 3A through 3F show various outputs and features of subcomponents of the optical communication system shown in FIG. 2.

In some embodiments, and at the transmitter-side (Tx), the DFB laser at 1538.51 nm is externally intensity-modulated by a 50-GBaud PAM-4 signal, using a 30-GHz Mach-Zehnder Modulator (MZM). The 50-GBaud PAM-4 signal is generated from a 80-Gsa/s digital-to-analog converter (DAC) with a 3-dB analog bandwidth of 18 GHz, and then amplified by a 30 GHz linear electrical driver before signal modulation. FIG. 3A shows the optical spectrum after MZM with PAM-4 modulation. One Erbium-doped fiber amplifier (EDFA) is used for optical signal boosting amplification before launching into the fiber.

For PAM-4 signal generation, nonlinear pre-distortion and linear pre-equalization is used after PAM-4 symbol mapping at the transmitter-side. Nyquist pulse shaping is then applied to further reduce the signal bandwidth. Since the amplitude of optical signal can be linearly extracted by coherent detection, the PAM-4 signal is modulated on the amplitude dimension with equal spacing. To achieve equally-spaced amplitudes, the PAM-4 signal is pre-distorted according to the modulation curve of the MZM. The principle of PAM-4 signal pre-distortion for MZM-based modulation is shown in FIG. 3C. As a result, the intensity eye-diagram is non-equally spaced as shown in FIG. 3D after the MZM.

The Mach-Zehnder Modulator (MZM) typically has a cos²(x) function as the intensity modulation curve, and an amplitude modulation curve of cos(x), as shown in FIG. 3C. For example, assuming the linearized equally-spaced output signal is S, the drive signal is arccos(S).

At the receiver-side (Rx), and as shown in FIG. 2, two distributed feedback (DFB) lasers with about 30-GHz frequency spacing are used as a signal light source and a local oscillator (LO) for heterodyne detection. The LO has an output power of 13.5 dBm and its polarization is manually aligned to the signal by a polarization controller (PC). A single 3-dB optical coupler for 180° optical hybrid is used before the 43 GHz balanced photodetector (BPD). FIG. 3B shows the optical spectra of combined signal with LO after the coupler. The detected signal is then amplified by a 50 GHz linear electrical amplifier before sampling by the 160 Gsa/s digital real-time scope. In some embodiments, and as seen in the context of FIG. 2, only one coupler, one BPD, and one ADC channel is required for heterodyne detection per polarization.

The sampled signal is down-converted to baseband with low-pass filtering and then re-sampled to 2 samples per symbol. Since coherent detection advantageously enables the availability of full electrical field information, digital chromatic dispersion (CD) compensation is enabled before clock recovery. This is followed by the use of a T/2-spaced cascaded multi-modulus algorithm (CMMA) for channel equalization.

Since no information is modulated in the phase of the optical signal, carrier phase recovery is not needed, and each amplitude level of the PAM-4 signal becomes a ring instead of a point in the I-Q plane due to the residual frequency offset and laser phase noise, as shown in FIG. 3E. As seen in FIG. 3E, four rings (the smallest ring has an amplitude close to zero) in the constellation correspond to the four amplitude levels of PAM-4. The corresponding amplitude distribution of recovered PAM-4 signals is shown in FIG. 3F. The bit error rate (BER) may be calculated after PAM-4 demodulation based on the signal amplitude. Thus, low-complexity phase insensitive coherent detection is enabled for a PAM-4 signal, as shown in this embodiment of the disclosed technology.

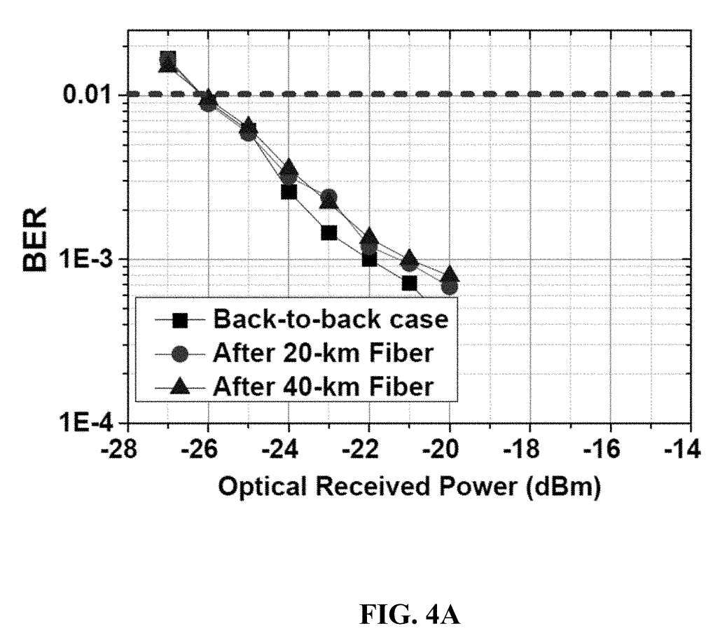

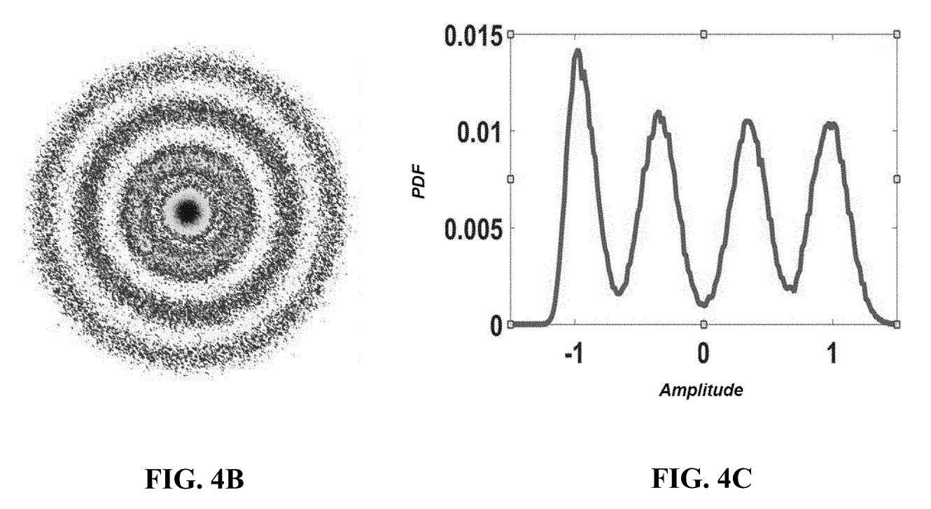

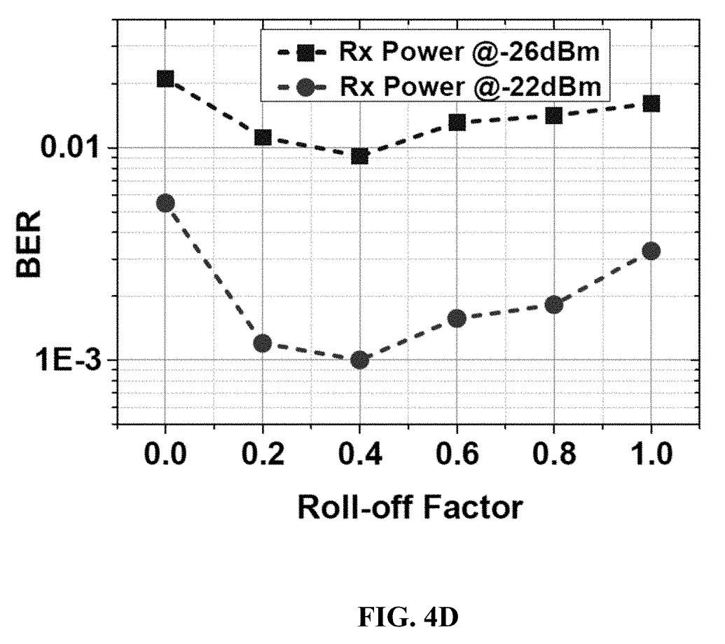

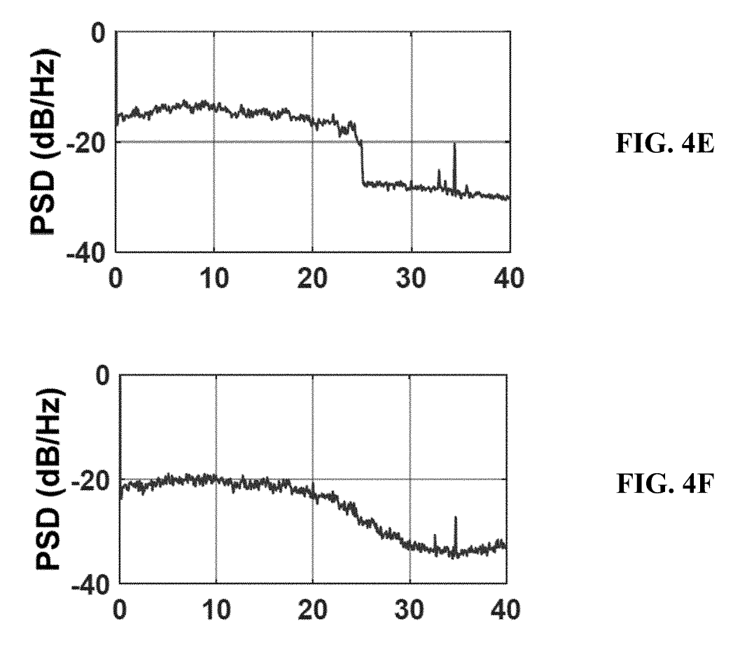

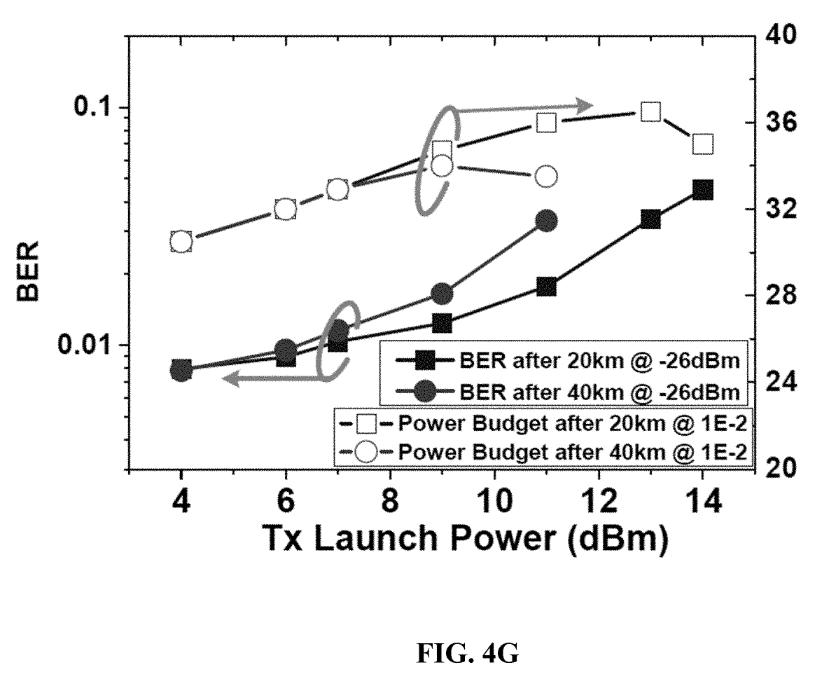

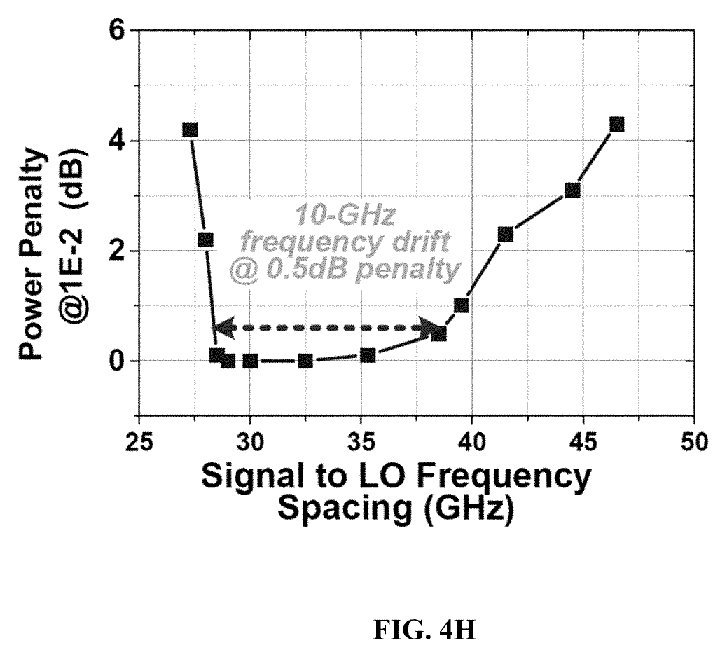

FIGS. 4A-4H show various experimental results, including performance curves, for the example optical communication system shown in FIG. 2. For example, BER results versus the received optical power for the back-to-back (BtB), 20- and 40-km fiber transmission cases, are shown in FIG. 4A. Assuming an advanced low-density parity check (LDPC) based forward error correcting (FEC) code is used, the required received power of BtB case is −26 dBm at a BER threshold of 1×10⁻². Due to the digital CD compensation, there is no obvious penalty at the BER of 1×10⁻² after 20- and 40-km fiber transmission.

In an example, the launch power is kept at −6 dBm, and the 32 dBm loss budget is achieved, which is enough to meet the PR-30 power budget (defined as having an upstream and downstream line rate of 10.3125 Gbit/s and a channel insertion loss of 29 dB). FIGS. 4B and 4C show the recovered PAM-4 constellation with four amplitude levels (rings) and the PAM-4 amplitude distribution at −26 dBm receiver power after 40-km fiber transmission.

FIG. 4D shows the BER performance under different roll-off factors for Nyquist pulse shaping in the back-to-back (BtB) case. Nyquist pulse shaping is an effective way to reduce the signal bandwidth, and consequently, to reduce the frequency spacing of LO and signal and the required bandwidth of components of the coherent receiver. FIGS. 4E and 4F show the electrical spectra of a received signal with a roll-off factor of 0.0 and 0.4, respectively. Although zero roll-off has the minimum signal bandwidth, the signal in this case is more sensitive to timing errors. In this example, the optimal Nyquist pulse shaping roll-off factor is determined to be around 0.4, with the frequency offset of the signal to the LO being 30 GHz.

FIG. 4G compares performance for different launch powers. As seen therein, increasing the launch power before fiber is an effective way to further increase the total power budget, however, it is limited by the fiber due to fiber nonlinearity impairments. The BER performance at −26 dB received power after 20- and 40-km fiber transmission degrades as the launch power increases greater than 6 dBm. FIG. 4G also shows the total link power budget after 20- and 40-km fiber transmission as a function of launch power. Therein, maximum power budgets of 36.5 dB and 34 dB are achieved after 20- and 40-km fiber transmission, respectively.

FIG. 4H shows the performance versus the frequency spacing between the signal and the LO, which quantifies the penalty of frequency drift, e.g. caused by a burst mode transmitter. As seen therein, there is less than 0.5 dB penalty even for a frequency drift range of 10 GHz.

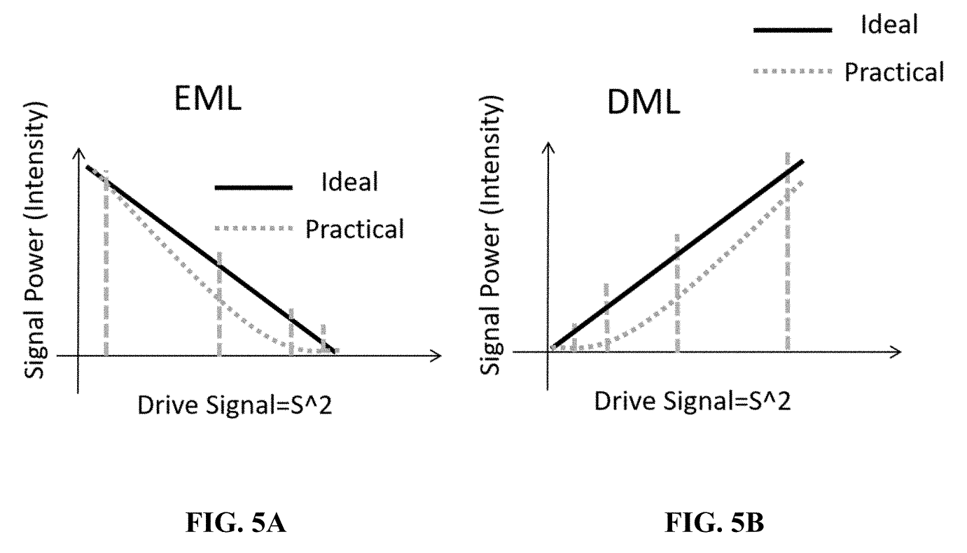

FIGS. 5A and 5B show examples of modulation laser characteristics, which may be used as alternatives for the MZM in the embodiment shown in FIG. 2. The ideal and practical relationships between the signal power and drive signal for an external modulation laser (EML) and a direct modulation laser (DML) are shown in FIG. 5A and FIG. 5B, respectively. As shown therein, the output signal intensity has a quasi-linear relation to that of drive signals. In some embodiments, and to achieve a linearized equally-spaced output, the drive signal is squared to convert the intensity to amplitude.

Example Embodiments of Optical Receiver Structures

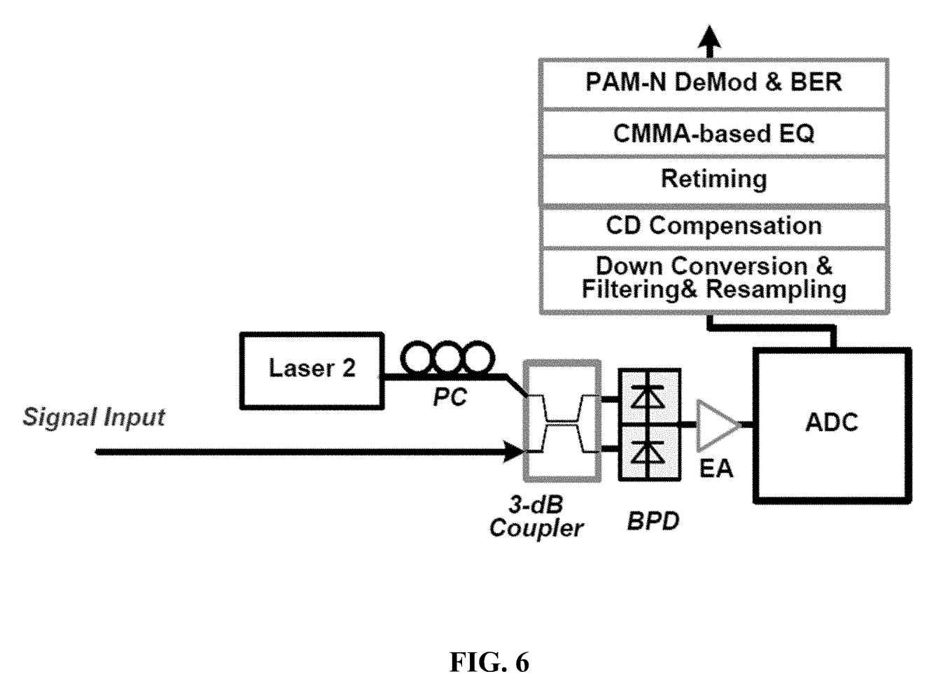

FIG. 6 shows an example of a single-polarization optical receiver structure, where in order to achieve simplified and phase insensitive heterodyne coherent detection, only one 180° optical hybrid (3-dB coupler) is required for each polarization. The local oscillator (Laser 2 in FIG. 6) has a frequency offset with respect to the signal carrier. In some embodiments, the frequency offset should be larger than the half of the signal bandwidth to avoid a cross-talk penalty. The signal processing operations subsequent to the analog to digital conversion (ADC) may be implemented using digital logic or using software-execution by a digital signal processor (DSP). In the DSP, the received signal is first down-converted to baseband, and filtered by a matching filter to the Nyquist pulse shaping used on the transmitter side. This operation is followed by the computation of the modulus (absolute value) of the baseband complex signal. The optical signal may be corrected for chromatic distortion (CD). After correction, the digital signal may be re-sampled by estimating the timing.

In some embodiments, the signal may then be equalized for signal recovery. In an example, the cascaded multi-modulus algorithm (CMMA) may be used. The PAM-N signal may then be demodulated based on a decision on the modulus of each sample.

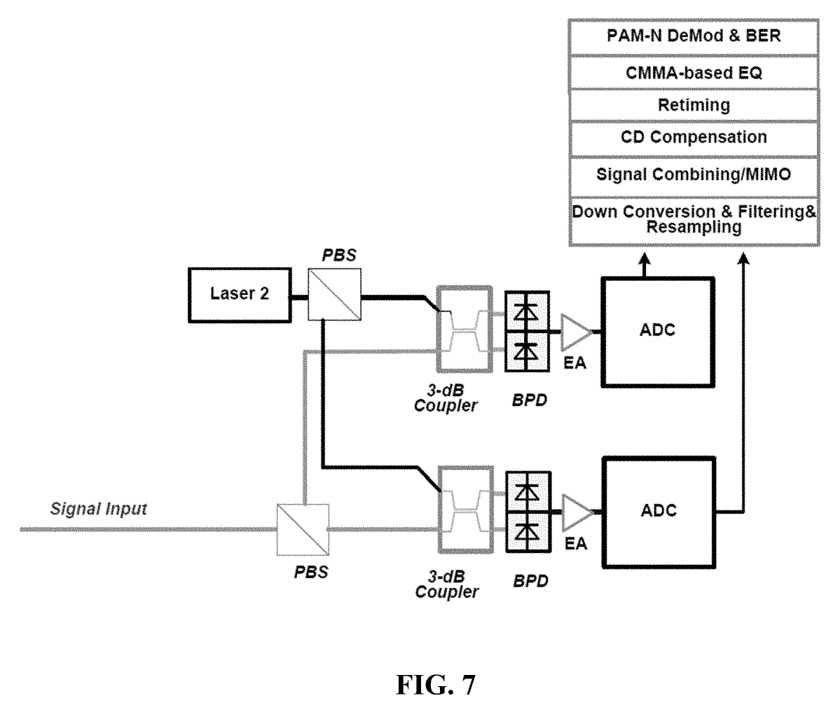

FIG. 7 shows an example of a dual-polarization optical receiver structure, which is similar to the single-polarization optical receiver structure in FIG. 6, but uses a polarization beam splitter (PBS) for polarization-diversity coherent detection. The local laser source Laser 2 may also be split through another PBS. The local polarized X and Y signal, and the X and Y components of the received signals may be coupled through a 3 dB coupler and passed through an X and a Y BPD respectively, to produce baseband electrical domain signals. The signals are then processed through an amplifier and an analog to digital conversion circuit (ADC) in the X and Y branches of processing. In some embodiments, the detected signals from the two branches are further processed through a same DSP, similar to as described with respect to FIG. 6. In some embodiments, multi-input multi-output (MIMO) processing is used for the transmission of dual-polarization signals.

Example Embodiments for Nyquist Shape Filtering

As discussed in this document, using a pulse shaping filter may reduce the bandwidth requirements of the transceiver, especially the receiver. For example, the pulse shaping filter may be a Nyquist filter. In some embodiments, the roll-off factor of the Nyquist pulse shaping filter may need to be optimized to improve performance of the optical communication system.

In some embodiments, a family of spectra that satisfy the Nyquist theorem is the raised cosine family whose spectra are

$$Z ( f ) = \{ \begin{matrix}{T}_{s} , & 0 \leq \vert f \vert \leq \frac{1 - β}{2 {T}_{s}} \\ \frac{{T}_{s}}{2} \{ 1 + cos [ \frac{π {T}_{s}}{β} ( \vert f \vert - \frac{1 - β}{2 {T}_{s}} ) ] \} , & \frac{1 - β}{2 {T}_{s}} < \vert f \vert \leq \frac{1 + β}{2 {T}_{s}} \\ 0 , & \vert f \vert > \frac{1 + β}{2 {T}_{s}}\end{matrix} \qquad ( 1 )$$

where the parameter roll-off factor β is a real number in the interval 0≤β≤1 that determines the bandwidth of the spectrum.

Since the spectrum is zero for |f|>(1+β)/2Tₛ, the bandwidth of the baseband pulse is (1+β)/2 Tₛ. For bandpass QAM modulation, the bandwidth is twice that:

$$BW = \frac{1 + β}{{T}_{s}} = ( 1 + β ) {R}_{s} \qquad ( 2 )$$

where Rₛ is the transmitted symbol rate.

The ideal low-pass rectangular spectrum is the special case where which has a passband equal to the symbol rate. The corresponding time-domain signal is

$$z ( t ) = \frac{cos ( π β \frac{t}{{T}_{s}} )}{1 - {( 2 β \frac{t}{{T}_{s}} )}^{2}} \times \frac{sin π \frac{t}{{T}_{s}}}{π \frac{t}{{T}_{s}}} \qquad ( 3 )$$

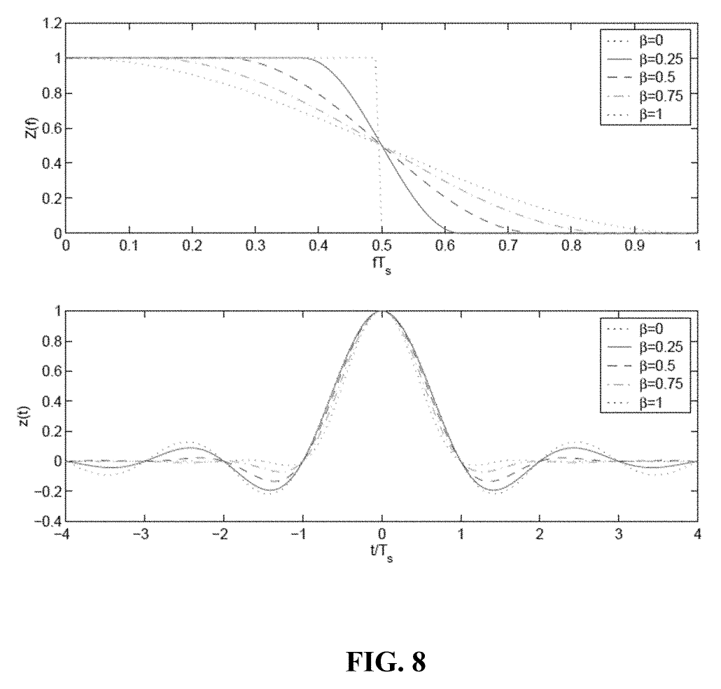

Note z(t) has zero-crossings at t=±Tₛ, ±2 Tₛ, . . . , and the time series corresponding to the special case β=0 (the ideal low-pass rectangular spectrum) is sin(πt/Tₛ)/(πt/Tₛ). The spectra and corresponding time series for various values of the roll-off factor (β) are plotted in the upper and lower plots of FIG. 8. As seen therein, larger values of β (corresponding to larger bandwidths) are characterized by a time-domain signal that has faster sidelobe decay rates.

In some embodiments, another family of spectra that satisfy the Nyquist theorem is the square-root raised cosine pulse shape p(t) and its Fourier transform P(f) are given by

$$P ( f ) = {\vert Z ( f ) \vert}^{1 / 2} \\ p ( t ) = \frac{2 β}{π \sqrt{{T}_{s}}} \frac{cos [ ( 1 + β ) π \frac{t}{{T}_{s}} ] + \frac{sin [ ( 1 - β ) π \frac{t}{{T}_{s}} ]}{4 β \frac{t}{{T}_{s}}}}{[ 1 - {( 4 β \frac{t}{{T}_{s}} )}^{2} ]} \qquad ( 4 )$$

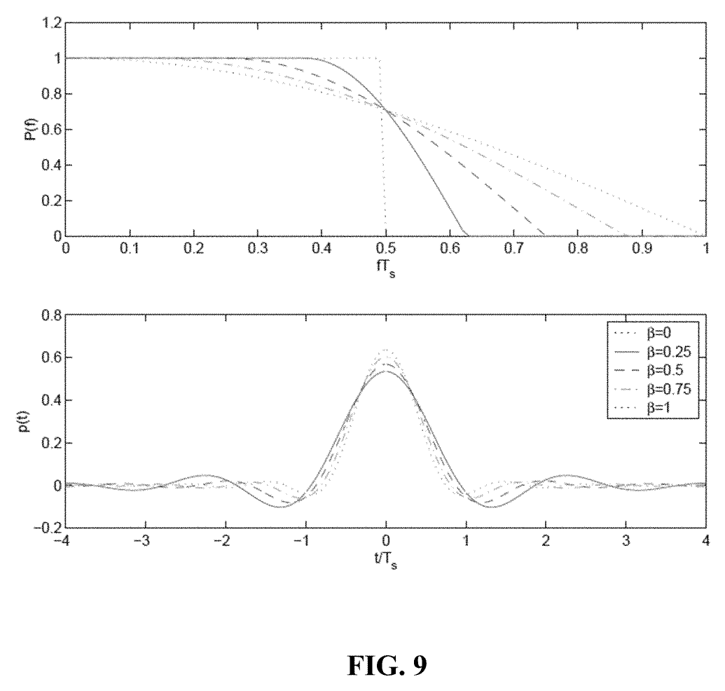

The spectra corresponding time series for various values of the roll-off factor (β8) for the square-root raised cosine pulse shape are plotted in the upper and lower plots of FIG. 9. As seen therein, the zero crossings of the time-domain pulse shape are spaced by Tₛ seconds (the symbol time). The spacing between the zero crossings is also a function of the roll-off factor β—as β approaches zero, the spacing approaches Tₛ.

The square-root raised cosine pulse shape is advantageously characterized by the corresponding matched filter output having no inter-symbol interference (ISI), but results in the pulse shape having an infinite support in the time-domain. Since a pulse cannot last indefinitely in a practical system, the pulse shape is truncated. The result of the truncation is the presence of non-zero side lobes in the frequency domain. In other words, the spectrum is no longer zero for |f|>(1β)/2Tₛ.

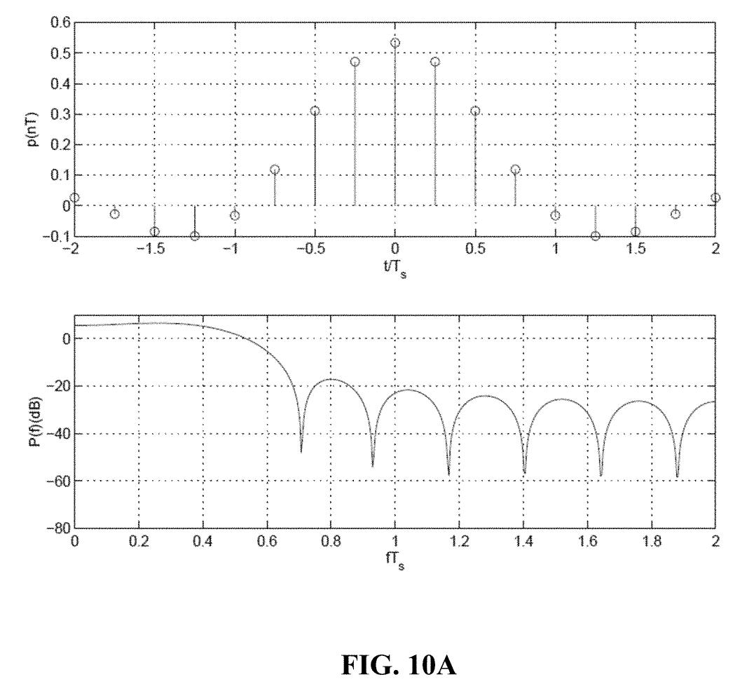

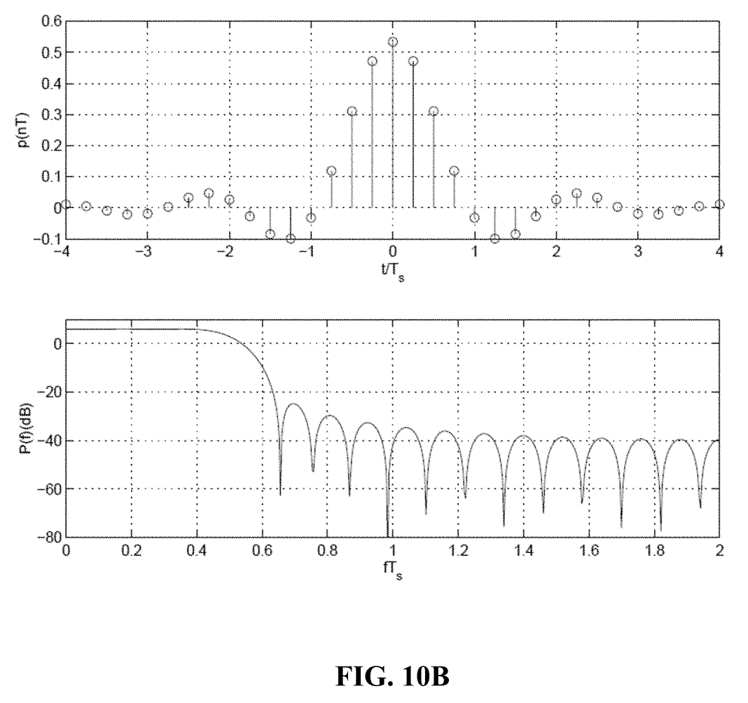

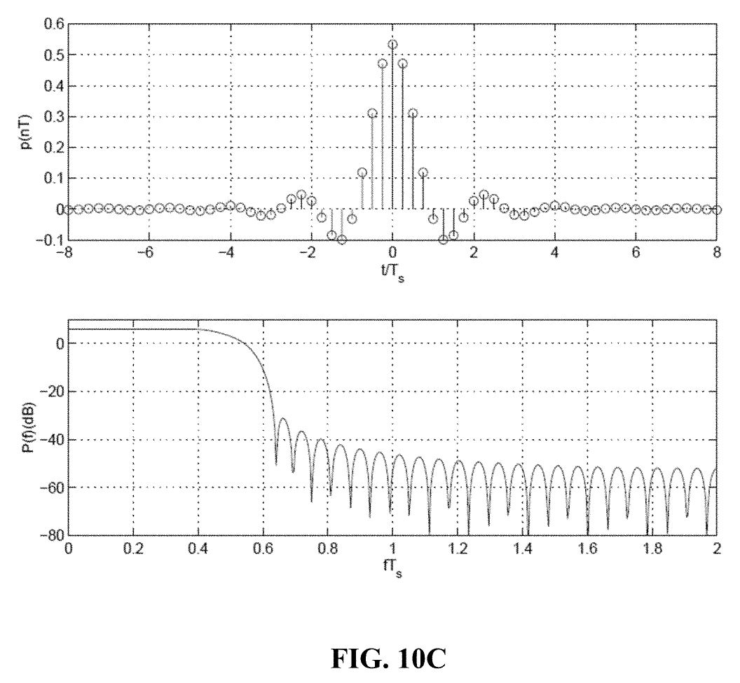

FIGS. 10A through 10C show the effect of truncation on the square-root raised cosine pulse shape. FIG. 10A shows the pulse sampled at N=4 samples/symbol and is truncated to 4 symbols as shown in the upper plot of FIG. 10A, and the lower plot shows the consequence of this truncation in the frequency domain: high sidelobes and a significant pass-band ripple. The stop band attenuation is only 18 dB, which is typically not enough for practical applications.

FIGS. 10B and 10C show the truncation and frequency-domain spectrum for the pulse sampled at N=4 samples/symbol, and truncated to 8 and 16 symbols, respectively. As seen in the lower plot of FIG. 10B, the pass band ripple has been eliminated and the out-of-band sidelobes are down about 25 dB. The sidelobes are 32 dB down as seen in the lower plot of FIG. 10C. As is evident, as the time span of the pulse is increased, the spectrum approaches the ideal spectrum. In general, the smaller the roll-off factor, the longer the pulse shape span needs to be in order to achieve a desired stop-band attenuation.

Typical systems need a stop band attenuation of about 40 dB, and an approximation of the number of filter symbol needed is given by

L_{symbol}=−44β+33, (5)

for 0.2<β≤0.75 and L_{symbol} is the length of the pulse shaping filter measured in symbols.

The resulting filter characteristics may be verified using the Discrete Fourier Transform (DFT) prior to their inclusion in embodiments of the disclosed technology.

Example Methods of Coherent Detection for PAM Signals

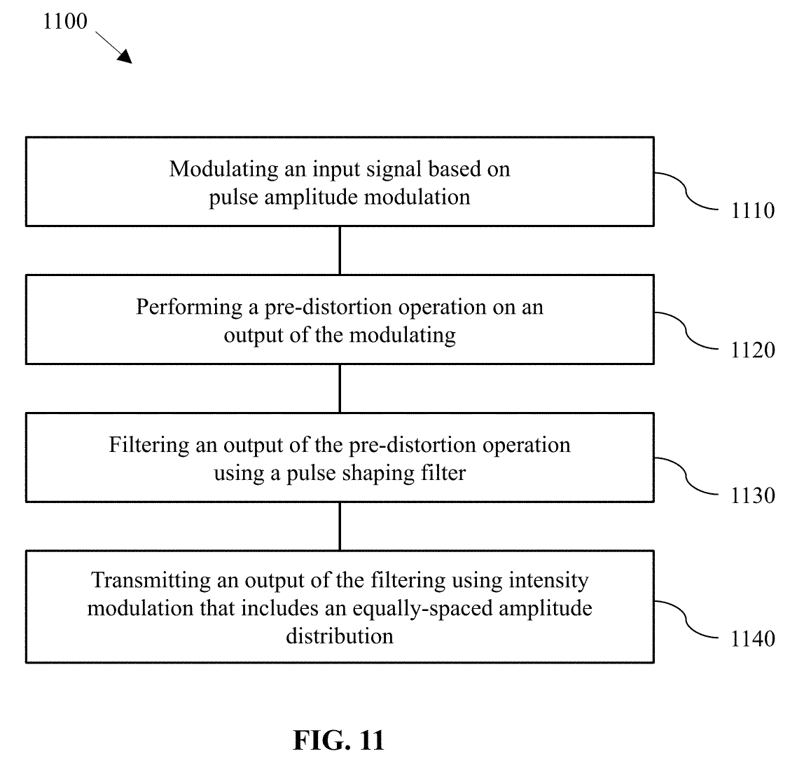

FIG. 11 shows a flowchart for an example method 1100 of coherent detection for PAM signals in an optical communication system, which may be implemented at an optical transmitter. The method 1100 includes, at step 1110, modulating an input signal based on pulse amplitude modulation. In some embodiments, the modulating of the input signal is performed by a digital-domain PAM modulator.

The method 1100 includes, at step 1120, performing a pre-distortion operation on an output of the modulating. In some embodiments, the pre-distortion operation is based on amplitude levels of the pulse amplitude modulation. In other words, the definition of the pre-distortion operation is based on the values of the PAM amplitude levels. Different amplitude levels would result in a different pre-distortion operation. In some embodiments, the pre-distortion operation may be implemented by a processor, and is based on either a hardware look-up table or real-time computations.

The method 1100 includes, at step 1130, filtering an output of the pre-distortion operation using a pulse shaping filter. In some embodiments, the pulse shaping filter is a Nyquist filter, and the roll-off factor of the Nyquist pulse shaping filter is based on a quality of a clock information and a bandwidth requirement, as described in the “Example Embodiments for Nyquist Shape Filtering” section.

The method 1100 includes, at step 1140, transmitting an output of the filtering using an intensity modulation, which may include an equally-spaced amplitude distribution. In some embodiments, the intensity modulation is performed using one of a direct modulation laser (DML), an external modulation laser (EML), or a Mach-Zehnder Modulator (MZM), as described in the “Example Experimental Embodiment of an Optical Communication System” section. In some embodiments, polarization division multiplexing may be used to transmit multiple similarly-generated polarized optical signals.

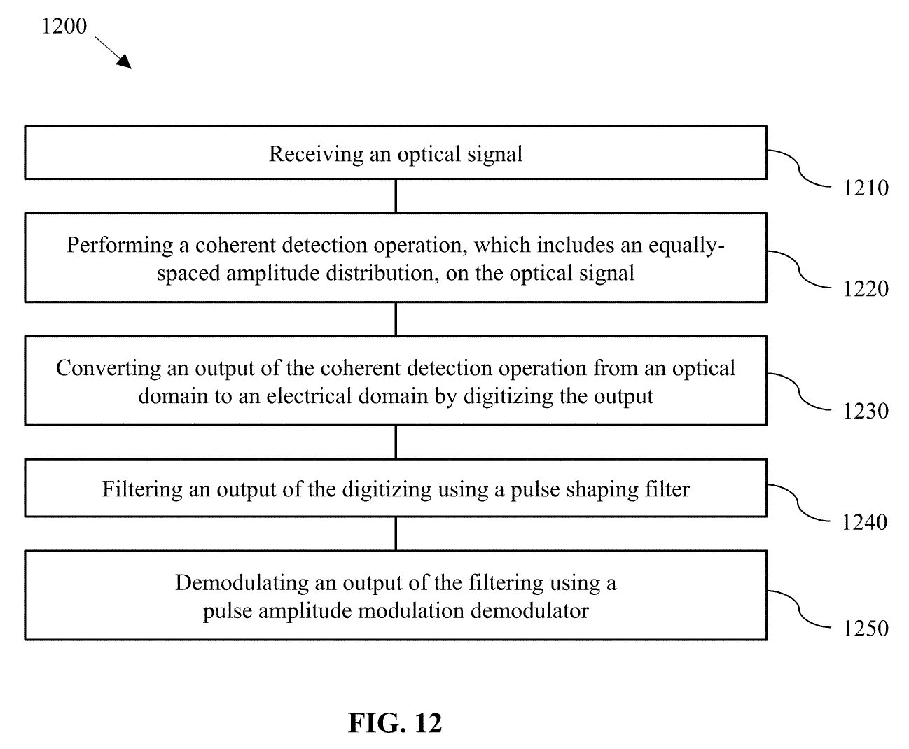

FIG. 12 shows a flowchart for an example method 1200 of coherent detection for PAM signals in an optical communication system, which may be implemented at an optical receiver. The method 1200 includes, at step 1210, receiving an optical signal.

The method 1200 includes, at step 1220, performing a coherent detection operation, which includes an equally-spaced amplitude distribution, on the optical signal. In some embodiments, the coherent detection operation is performed by a heterodyne coherent receiver.

In some embodiments, the optical signal may include multiple polarizations. The method 1200 may further include generating a reference optical signal, coupling one of the multiple polarizations with the reference optical signal, and processing the coupled signal using a balanced photodiode, as part of the coherent detection operation.

The method 1200 includes, at step 1230, converting an output of the coherent detection operation from an optical domain to an electrical domain by digitizing the output. In some embodiments, step 1230 may be performed by an analog-to-digital converter.

The method 1200 includes, at step 1240, filtering an output of the digitizing using a pulse shaping filter. In some embodiments, the pulse shaping filter is a Nyquist filter, and the roll-off factor of the Nyquist pulse shaping filter is based on a quality of a clock information and a bandwidth requirement, as described in the “Example Embodiments for Nyquist Shape Filtering” section.

The method 1200 includes, at step 1250, demodulating an output of the filtering using a pulse amplitude modulation demodulator. In some embodiments, the method 1200 may further include equalizing the filtered output prior to demodulation. For example, the equalization is based on a cascaded multi-modulus algorithm (CMMA). Upon performing the equalization, further output-side processing may be performed to demap PAM symbols into data bits, and then recovering data bits by performing error correction decoding, if needed. As can be seen, the PAM technique enables recovery of information bits that have been modulated and transmitted by the transmission apparatus.

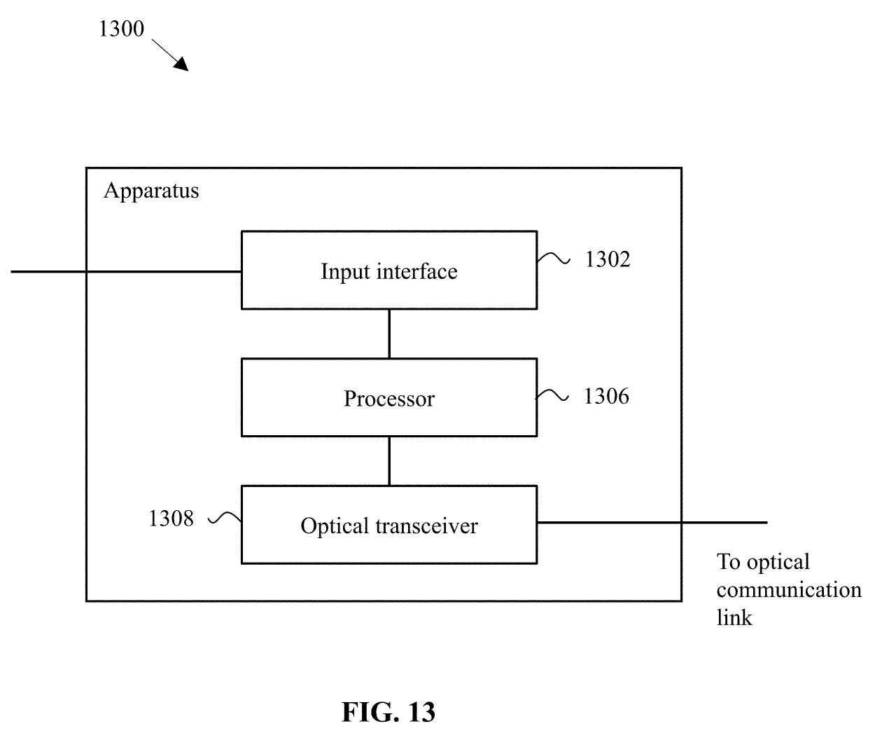

FIG. 13 shows an example of an optical transmitter or receiver apparatus 1300 where the techniques described herein may be performed. The apparatus 1300 may be include an input interface 1302 at which user data may be received for transmission over an optical communication link. The apparatus may include a processor 1306 that is configured to perform the various techniques described in the present document. The apparatus 1300 may also include an optical transceiver 1308 that includes a transmitter circuit and a receiver circuit that performs various operations, including methods 1100 and 1200, described herein.

It is intended that the specification, together with the drawings, be considered exemplary only, where exemplary means an example and, unless otherwise stated, does not imply an ideal or a preferred embodiment. As used herein, “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method for digital communication, implemented at an optical transmitter, the method comprising:
modulating an input signal based on pulse amplitude modulation;
performing a pre-distortion operation on an output of the modulating, wherein the pre-distortion operation is based on amplitude levels of the pulse amplitude modulation;
filtering an output of the pre-distortion operation using a pulse shaping filter; and
transmitting an output of the filtering using intensity modulation, wherein the intensity modulation comprises an equally-spaced amplitude distribution.

2. The method of claim 1, wherein the intensity modulation is performed using one of a direct modulation laser (DML), an external modulation laser (EML), or a Mach-Zehnder Modulator (MZM).

3. (canceled)

4. The method of claim 1, wherein the pulse shaping filter is a Nyquist filter.

5. The method of claim 4, wherein a roll-off factor of the Nyquist filter is based on a quality of a clock information and a bandwidth requirement.

6. A method for digital communication, implemented at an optical receiver, the method comprising:
receiving an optical signal comprising a signal based on pulse amplitude modulation and a pre-distortion operation, wherein the pre-distortion operation is based on amplitude levels of the pulse amplitude modulation;
performing a coherent detection operation on the optical signal, wherein the coherent detection comprises an equally-spaced amplitude distribution;
converting an output of the coherent detection operation from an optical domain to an electrical domain by digitizing the output;
filtering an output of the digitizing using a pulse shaping filter; and
demodulating an output of the filtering using a pulse amplitude modulation demodulator.

7. The method of claim 6, wherein the output of the filtering is equalized prior to demodulating, and wherein the equalization is based on a cascaded multi-modulus algorithm.

8. The method of claim 6, wherein the optical signal comprises a plurality of polarizations, and wherein performing the coherent detection operation for each of the plurality of polarizations comprises:
generating a reference optical signal;
coupling one of the plurality of polarizations with the reference optical signal; and
processing the coupled signal using a balanced photodiode.

9. The method of claim 6, wherein the pulse shaping filter is a Nyquist filter.

10. The method of claim 9, wherein a roll-off factor of the Nyquist filter is based on a quality of a clock information and a bandwidth requirement.

11. An apparatus for digital communication, comprising:
a modulator configured to modulate an input signal based on pulse amplitude modulation;
a processor configured to perform a pre-distortion operation on an output of the modulator, wherein the pre-distortion operation is based on amplitude levels of the pulse amplitude modulation;
a pulse shaping filter configured to filter an output of the pre-distortion operation; and
an optical transmitter configured to transmit an output of the filtering using intensity modulation, wherein the intensity modulation comprises an equally-spaced amplitude distribution.

12. The apparatus of claim 11, wherein the pre-distortion operation is performed by the processor based on a hardware look-up table or a set of computations.

13. (canceled)

14. The apparatus of claim 11, wherein the pulse shaping filter is a Nyquist filter.

15. The apparatus of claim 14, wherein a roll-off factor of the Nyquist filter is based on a quality of a clock information and a bandwidth requirement.

16. An apparatus for digital communication, comprising:
an optical receiver configured to receive an optical signal comprising a signal based on pulse amplitude modulation and a pre-distortion operation, wherein the pre-distortion operation is based on amplitude levels of the pulse amplitude modulation;
a heterodyne coherent receiver configured to perform a coherent detection operation on an output of the optical receiver, wherein the coherent detection comprises an equally-spaced amplitude distribution;
an analog-to-digital converter configured to convert an output of the heterodyne coherent receiver from an optical domain to an electrical domain;
a pulse shaping filter configured to filter an output of the analog-to-digital converter; and
a pulse amplitude modulation demodulator configured to demodulate an output of the pulse shaping filter.

17. The apparatus of method 16, further comprising:
an equalizer configured to equalize the output of the filtering prior to demodulating, wherein the equalizing is based on a cascaded multi-modulus algorithm.

18. The apparatus of claim 16, wherein the optical signal comprises a plurality of polarizations, and wherein performing the coherent detection operation for each of the plurality of polarizations comprises:
generating a reference optical signal;
coupling one of the plurality of polarizations with the reference optical signal; and
processing the coupled signal using a balanced photodiode.

19. The apparatus of claim 16, wherein the pulse shaping filter is a Nyquist filter.

20. The apparatus of claim 19, wherein a roll-off factor of the Nyquist filter is based on a quality of a clock information and a bandwidth requirement.
